(19) United States
(12) Patent Application Publication
(10) Pub. No.: US 2016/0168660 A1
(43) Pub. Date: Jun. 16, 2016

(54) ANISOTROPIC COMPLEX SINTERED MAGNET COMPRISING MnBi WHICH HAS IMPROVED MAGNETIC PROPERTIES AND METHOD OF PREPARING THE SAME

(71) Applicant: LG ELECTRONICS INC., Seoul (KR)

(72) Inventors: Jinbae KIM, Seoul (KR); Yangwoo BYUN, Seoul (KR); Sanggeun CHO, Seoul (KR)

(73) Assignee: LG ELECTRONICS INC., Seoul (KR)

(21) Appl. No.: 14/837,800

(22) Filed: Aug. 27, 2015

(30) Foreign Application Priority Data
Dec. 15, 2014 (KR) 10-2014-0180552

(51) Int. Cl. C22C 12/00; H01F 1/059; B22F 1/00; B22F 3/16; B22D 11/00; B22F 3/105; B22F 3/15; B22F 3/14; B22F 9/04; C22F 1/16; H01F 1/055; B22F 3/087

(52) U.S. Cl. CPC C22C 12/00; H01F 1/0557; H01F 1/059; B22F 1/0003; B22F 1/0059; B22F 3/16; B22F 3/087; B22F 3/105; B22F 3/15; B22F 3/14; B22F 9/04; C22F 1/16; B22D 11/001; B22F 2003/1054; B22F 2003/1051; B22F 2009/043; B22F 2301/30; B22F 2301/45; B22F 2301/355; B22F 2301/00; B22F 2303/01; B22F 2304/10

(57) ABSTRACT

The present invention relates to a method of preparing an anisotropic complex sintered magnet having MnBi, that includes: (a) preparing a non-magnetic phase MnBi-based ribbon by a rapidly solidification process (RSP); (b) heat treating the non-magnetic phase MnBi-based ribbon to convert the non-magnetic phase MnBi-based ribbon into a magnetic phase MnBi-based ribbon; (c) grinding the magnetic phase MnBi-based ribbon to form a MnBi hard magnetic phase powder; (d) mixing the MnBi hard magnetic phase powder with a rare-earth hard magnetic phase powder; (e) magnetic field molding the mixture obtained in step (d) by applying an external magnetic field to form a molded article; and (f) sintering the molded article.

### CROSS-REFERENCE TO RELATED APPLICATION

This application claims priority from and the benefit under 35 U.S.C. §119(a) of Korean Application No. 10-2014-0180552, filed on Dec. 15, 2014, the contents of which is incorporated by reference herein in its entirety.

### BACKGROUND OF INVENTION

1. Field of the Invention

The present invention relates to an anisotropic complex sintered magnet comprising MnBi which has improved magnetic properties, and a method of preparing the same.

2. Background of Invention

A neodymium magnet is a molding sintered article that exhibits excellent magnetic properties, and includes neodymium (Nd), iron oxide (Fe), and boron (B) as main components. There is increasing demand for these high property neodymium (Nd)-based bulk magnets, but an imbalance in the supply of resources of rare-earth elements has become a big obstacle for the supply of a high performance motor needed for the next-generation industry.

A ferrite magnet is inexpensive and has stable magnetic properties. The ferrite magnet is used when a strong magnetic force is not needed, and usually exhibits a black color. The ferrite magnet is used for various products such as D.C motors, compasses, telephone sets, tachometers, speakers, speedometers, TV sets, reed switches, and clock movements. The advantage of the ferrite magnet is that it is lightweight and inexpensive. The problem of the ferrite magnet is that it fails to exhibit excellent magnetic properties to such an extent to replace the expensive neodymium (Nd)-based bulk magnet. Accordingly, there is an emerging need for developing a novel magnetic material having high magnetic properties, which can replace a rare-earth-based magnet.

MnBi is a permanent magnet made of a rare-earth-free material. MnBi has a larger coercive force than a Nd2Fe14B permanent magnet at a temperature of 150° C. or more because its coercive force has a positive temperature coefficient between the temperature of −123° C. and 277° C. Accordingly, MnBi is a material suitable for motor driven at a high temperatures (100° C. to 200° C.). The LTP MnBi exhibits a better performance than the conventional ferrite permanent magnet when comparison is made using a (BH)max value. The LTP MnBI exhibits a performance equivalent to or more than that of a rare-earth Nd2Fe14B bond magnet. Thus, the LTP MnBi is a material which may replace these magnets.

The conventional MnBi permanent magnet has the problem of a relatively lower saturation magnetization value (theoretically 80 or less emu/g) compared to rare-earth permanent magnets. Its low saturation magnetization value can be improved if the MnBi is complexed with a rare-earth hard magnetic phase, such as SmFeN or NdFeB, to form a complex sintered magnet. Further, the temperature stability can be secured by complexing the MnBi having a positive temperature coefficient with hard magnetic phases having a negative temperature coefficient with regard to the coercive force. Meanwhile, a rare-earth hard magnetic phase, such as SmFeN, cannot be used as a sintered magnet because its phase is decomposed at high temperatures (about 600° C. or more).

### SUMMARY OF INVENTION

The present inventors have discovered that an anisotropic sintered magnet can be obtained by complexing a MnBi powder with a rare-earth hard magnetic phase powder if a MnBi ribbon, prepared by a rapidly solidification process (RSP) to form a micro crystal phase of MnBi, and a rare-earth hard phase are sintered together. Also, the present inventors have discovered that the obtained anisotropic complex sintered magnet exhibits excellent magnetic properties.

Accordingly, an object of the present invention is to provide a method of preparing an anisotropic complex sintered magnet comprising MnBi, the method comprising: preparing an MnBi ribbon by a rapidly solidification process (RSP).

Another object of the present invention is to provide an anisotropic complex sintered magnet prepared by the method of preparing an anisotropic complex sintered magnet including the rapidly solidification process (RSP).

Still another object of the present invention is to provide a final product including the prepared anisotropic complex sintered magnet.

To achieve these and other advantages and in accordance with the purpose of the present invention, as embodied and broadly described herein, the present invention provides a method of preparing an anisotropic complex sintered magnet comprising MnBi, the method comprising: (a) preparing a non-magnetic phase MnBi ribbon by a rapidly solidification process (RSP); (b) heat treating the non-magnetic phase MnBi-based ribbon to convert the non-magnetic phase MnBi-based ribbon into a magnetic phase MnBi-based ribbon; (c) grinding the magnetic phase MnBi-based ribbon to form a MnBi hard magnetic phase powder; (d) mixing the MnBi hard magnetic phase powder with a rare-earth hard magnetic phase powder; (e) magnetic field molding the mixture obtained in step (d) by applying an external magnetic field; and (f) sintering the molded article.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 illustrates a schematic view of a process of preparing an anisotropic complex sintered magnet.

FIG. 2 illustrates a distribution analysis of MnBi and SmFeN in an MnBi/SmFeN (20 wt %) complex sintered magnet by a scanning electron microscope (SEM).

FIG. 3 illustrates magnetic properties (25° C.) of MnBi and MnBi/SmFeN (15, 20, and 35 wt %) sintered magnets.

FIG. 4 illustrates magnetic properties (150° C.) of MnBi and MnBi/SmFeN (15, 20, and 35 wt %) sintered magnets.

### DETAILED DESCRIPTION OF INVENTION

### (a) Process of Preparing MnBi Ribbon by a Rapidly Solidification Process (RSP)

The rapidly solidification process (RSP) is a process which has been widely used since the year 1984. The (RSP) is a procedure of forming a solidified micro structure through a rapid extraction of a heat energy including superheat and latent heat during the transition period from a liquid state at high temperature to a solid state at normal temperature or an ambient temperature. Various rapidly solidification processes have been developed and used, including a vacuum induction melting method, a squeeze casting method, a splat quenching method, a melt spinning method, a planer flow casting method, a laser or electron beam solidification method. All of the methods form a solidified micro structure through a rapid extraction of heat.

Before the solidification occurs, the rapid extraction of heat causes undercooling at a high temperature of 100° C. or more, and is compared with a typical casting method which accompanies a change in temperature of 1° C. or less per second. The cooling rate may be 5 to 10 K/s or more, 10 to 10² Ks or more, 10³ to 10⁴ K/s or 10⁴ to 10⁵ K/s or more, and the rapidly solidification process is responsible for forming a solidified micro structure.

A material with an MnBi alloy composition is heated and molten, and the melt is injected from a nozzle and is brought into contact with a cooling wheel, which is rotated with respect to the nozzle to rapidly cool and solidify the melt, thereby continuously preparing an MnBi ribbon.

In the method of the present invention, when a sintered magnet is synthesized to form a hybrid structure of an MnBi hard magnetic phase and a rare-earth hard magnetic phase, it is very important to secure the micro crystalline phase of the MnBi ribbon by preparing the MnBi ribbon through a rapidly solidification process (RSP) in order to sinter a rare-earth hard magnetic phase together, which is difficult to be sintered below 300° C. In an exemplary embodiment, when the crystal grain of an MnBi ribbon prepared through the rapidly solidification process (RSP) of the present invention has a crystal size of 50 to 100 nm, high magnetic properties are obtained during the formation of the magnetic phase.

When a rapid cooling procedure is performed by using a cooling wheel during the rapidly cooling process (RSP), the wheel speed may affect properties of the rapidly cooled alloy. In the rapidly solidification process using a cooling wheel, the faster the circumference speed of the wheel, the greater cooling effect may be obtained for the material which is brought into contact with the wheel. According to an exemplary embodiment, in the rapidly solidification process of the present invention, the circumference speed of the wheel may be 10 to 300 m/s or 30 to 100 m/s, preferably 60 to 70 m/s.

The MnBi ribbon, which is a non-magnetic phase prepared through the rapidly solidification process (RSP) of the present invention, may have a composition represented by MnₓBi_{100-x,} wherein X is 45 to 55. Preferably the composition of MnBi may be Mn₅₀Bi₅₀, Mn₅₁Bi₄₉, Mn₅₂Bi₄₈, Mn₅₃Bi₄₇, Mn₅₄Bi₄₆, or Mn₅₅Bi₄₅.

(b) Step of Converting Non-Magnetic Phase MnBi-Based Ribbon into Magnetic Phase MnBi-Based Ribbon

The next step imparts magnetic properties to the prepared non-magnetic phase MnBi-based ribbon. According to an exemplary embodiment, a low temperature heat treatment may be performed in order to impart the magnetic properties, and a magnetic phase Mn-Bi-based ribbon is formed by performing a low temperature heat treatment, for example, 280° C. to 340° C. and a vacuum and inert gas atmosphere. Heat treatment may be performed for 3 to 24 hours to induce diffusion of Mn included in the non-magnetic phase MnBi-based ribbon, and through this, an MnBi-based magnetic body may be prepared. Through a heat treatment step, the MnBi low temperature phase (LTP) may be formed when the magnetic phase is in an amount of 90% or more, more preferably 95% or more. When the MnBi low temperature phase is included in an amount of about 90% or more, the MnBi-based magnetic body may exhibit excellent magnetic properties.

### (c) Step of Preparing Hard Magnetic Phase Powder

In the next step, an MnBi hard magnetic phase powder is prepared by grinding the MnBi low temperature phase MnBi alloy.

In the process of grinding the MnBi hard magnetic phase powder, the grinding efficiency may be enhanced and the dispersibility may be improved, preferably by a process using a dispersing agent. A dispersing agent may be selected from the group consisting of oleic acid (C₁₈H₃₄O₂), oleylamine (C₁₈H₃₇N), polyvinylpyrrolidone, and polysorbate. However, the present invention is not limited thereto, and the dispersing agent may include oleic acid in an amount of 1 to 10 wt % based on the weight of the powder.

In the process of grinding the MnBi hard magnetic phase powder, a ball milling may be used. In this embodiment, the ratio of the magnetic phase powder, the ball, the solvent, and the dispersing agent is about 1:20:6:0.12 (by mass), and the ball milling may be performed by setting the ball to Φ3 to Φ5.

According to an exemplary embodiment of the present invention, the grinding process using a dispersing agent of the MnBi hard magnetic phase powder may be performed for 3 to 8 hours, and the size of the MnBi hard magnetic phase powder, which is completely subjected to the LTP heat treatment and the grinding process, may have a diameter of 0.5 to 5 μm. When the diameter exceeds 5 μm, the coercive force may deteriorate.

Meanwhile, apart from the procedure of preparing the MnBi hard magnetic phase powder, the rare-earth hard magnetic phase powder is also separately prepared.

In an exemplary embodiment, the rare-earth hard magnetic phase may be represented by R—Co or R—Fe—B, wherein R is a rare-earth element selected from the group consisting of Sc, Y, La, Ce, Pr, Nd, Pm, Sm, Eu, Gd, Tb, Dy, Ho, Er, Tm, Yb, and Lu, and may be preferably SmFeN, NdFeB, or SmCo.

The size of the rare-earth hard magnetic phase powder, which is subjected to the grinding process, may be 1 to 5 μm. When the diameter exceeds 5 μm, the coercive force may significantly deteriorate.

(d) Step of Mixing MnBi Hard Magnetic Phase Powder with Rare-Earth Hard Magnetic Phase Powder

In the mixing of the MnBi hard magnetic phase with the rare-earth hard magnetic phase, a magnetic field molded article may also be prepared by using a lubricant. The lubricant may be selected from ethyl butyrate, methyl caprylate, ethyl laurate, or stearate, and preferably, ethyl butyrate, methyl caprylate, methyl laurate and zinc stearate, and the like may be used. In particular, in an even more preferred embodiment, methyl caprylate is included in an amount of 1 to 10 wt %, 3 to 7 wt %, or 5 wt % based on the weight of the powder.

According to an exemplary embodiment, it is preferred that the process of mixing the MnBi hard magnetic phase with the rare-earth hard magnetic phase is rapidly performed within 1 minutes to 1 hour, such that the powders are not ground. It is important to mix the hard magnetic phases without any grinding as maximally as possible.

### (e) Step of Magnetic Field Molding by Applying External Magnetic Field

In the present step, the anisotropy is secured by aligning the magnetic field direction of the alloy powder in parallel with the C-axis direction of the powder through the process of magnetic field molding. The anisotropic magnet, which secures the anisotropy in a single-axis direction through the magnetic field molding, as described above, has excellent magnetic properties as compared to an isotropic magnet.

The magnetic field molding may be performed by using a magnetic field injection molding machine, a magnetic field molding press, and the like, and may be performed by an axial die pressing (ADP) method, a transverse die pressing (TDP) method, and the like, but the present invention is not limited thereto.

The magnetic field molding step may be performed under a magnetic field of 0.1 to 5.0 T, 0.5 to 3.0 T, or 1.0 to 2.0 T.

### (f) Step of Sintering Molded Article

Any sintering method may be used as a selective heat treatment at low temperature for suppressing the growth and oxidation of particles when a compacted magnet is prepared, including a hot press sintering, a hot isotactic press sintering, a spark plasma sintering, a furnace sintering, a microwave sintering, and the like, but the present invention is not limited thereto.

Another embodiment of the present invention is to provide an anisotropic complex sintered magnet including MnBi and a rare-earth hard magnetic phase, which are prepared by the aforementioned method of the present invention. In this embodiment, an MnBi ribbon is obtained by using a rapidly solidification process when an MnBi alloy is prepared that has a crystal grain size of 50 to 100 nm.

For the anisotropic complex sintered magnet including MnBi of the present invention, the content of the rare-earth hard magnetic phase may be controlled, so that the coercive force intensity and the magnetization size may be adjusted in an anisotropic complex sintered magnet including MnBi.

In particular, the anisotropic complex sintered magnet including MnBi of the present invention is advantageous in making a high property magnet having a single-axis anisotropy through a single-axis magnetic field molding and a sintering process.

In an exemplary embodiment, the magnet of the present invention includes MnBi as a rare-earth-free hard magnetic phase in an amount of 55 to 99 wt %, and may include a rare-earth hard magnetic phase in an amount of 1 to 45 wt %. If the content of the rare-earth hard magnetic phase exceeds 45 wt %, it becomes disadvantageously difficult to perform a sintering.

In a preferred exemplary embodiment, when SmFeN is used as the rare-earth hard magnetic phase, the content thereof may be 5 to 35 wt %.

The anisotropic complex sintered magnet including MnBi of the present invention exhibits excellent magnetic properties, and the maximum magnetic energy product (BHₘₐₓ) is 5 to 15 MGOe at 25° C. and 150° C.

The anisotropic complex sintered magnet including MnBi of the present invention, as described above, may be widely used for a refrigerator motor and air conditioner compressor, a washing machine driving motor, a mobile handset vibration motor, a speaker, a voice coil motor, the determination of the position of a hard disk head for a computer using a linear motor, a zoom, an iris diaphragm, and a shutter of a camera, an actuator of a precision machine, an automobile electrical part such as a dual clutch transmission (DCT), an anti-lock brake system (ABS), an electric power steering (EPS) motor and a fuel pump, and the like due to excellent magnetic properties thereof.

It is possible to replace the conventional rare-earth bond magnet because the anisotropic complex sintered magnet including MnBi of the present invention improves a low saturation magnetization value of MnBi, possesses high temperature stability, and exhibits excellent magnetic properties.

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, the present invention will be described in more detail through the Examples. These Examples are provided only for more specifically describing the present invention, and it will be obvious to a person with ordinary skill in the art to which the present invention pertains that the scope of the present invention is not limited by these Examples.

### EXAMPLES

### Preparation of Anisotropic Complex Sintered Magnet Including MnBi

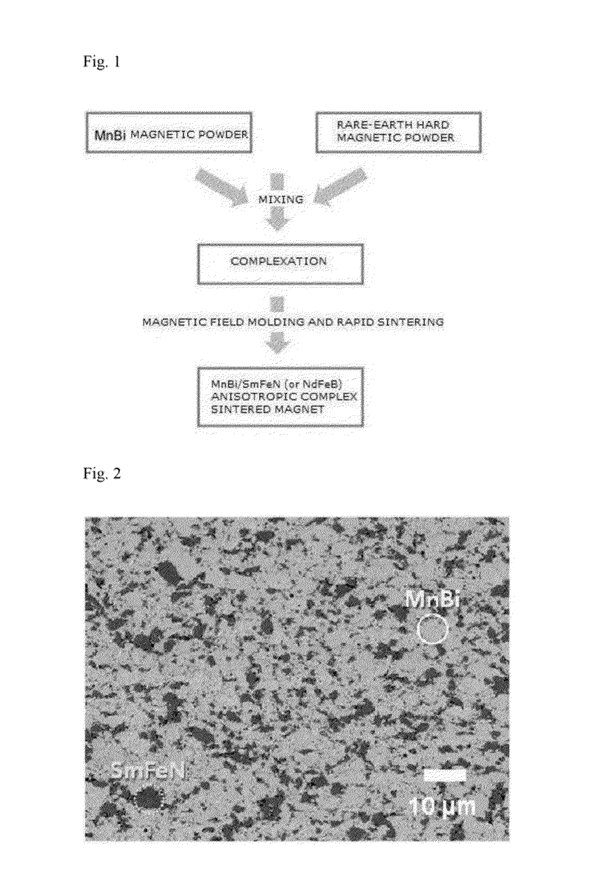

According to the schematic view illustrated in FIG. 1, an anisotropic complex sintered magnet was prepared. First, an MnBi ribbon was prepared by setting a wheel speed in a rapidly solidification process (RSP) for preparing an MnBi ribbon to 60 to 70 m/s. A Bi phase having a crystal size of 50 to 100 nm was used.

In order to impart magnetic properties to the non-magnetic phase MnBi ribbon, a low temperature heat treatment was performed under a temperature of 280 to 340° C., a vacuum and inert gas atmosphere. A magnetic phase MnBi-based ribbon was formed by performing a heat treatment for 3 to 24 hours to induce diffusion of Mn included in the non-magnetic phase MnBi ribbon, and an MnBi-based magnetic body was obtained through this preparation.

Next, a complex process using a ball milling was performed. The grinding process was performed for about 5 hours, and the ratio of the magnetic phase powder, the ball, the solvent, and the dispersing agent was set to about 1:20:6:0.12 (by mass), and the ball was set to Φ3 to Ψ5.

Subsequently, the SmFeN hard magnetic body powder (15, 20, or 35 wt %) was mixed with the magnetic powder (85, 80, or 65 wt %) prepared by using a ball milling without any grinding as maximally as possible. A molding was performed under a magnetic field of about 1.6 T, and then a sintered magnet was prepared by performing a rapid sintering at 250 to 320° C. for 1 to 10 minutes using a hot press in a vacuum and an inert gas atmospheric state.

Among the sintered magnets thus prepared, the cross-sectional state of a complex sintered magnet having a weight ratio of MnBi/SmFeN of 80:20 was observed by a scanning electron microscope (SEM), and is illustrated in FIG. 2. In FIG. 2, it is confirmed that a rare-earth-free MnBi hard magnetic phase and a rare-earth SmFeN hard magnetic phase are uniformly distributed.

### Magnetic Properties of Anisotropic Complex Sintered Magnet at 25° C.

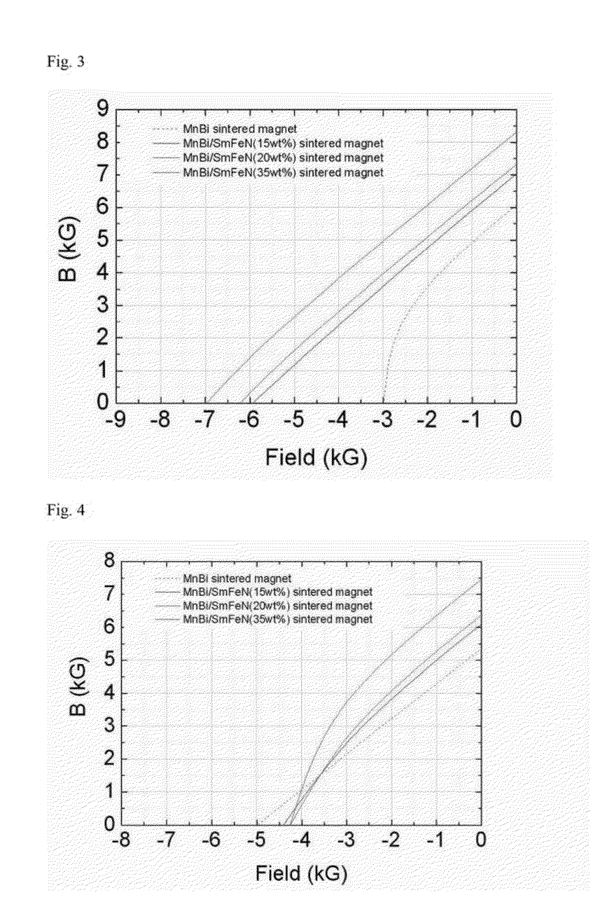

The residual magnetic flux density (Br), the induced coercive force (H_{CB}), and the maximum magnetic energy product [(BH)ₘₐₓ] of the MnBi and MnBi/SmFeN (15, 20, and 35 wt %) sintered magnets were measured at a normal temperature (25° C.) by using a vibrating sample magnetometer (VSM, Lake Shore #7300 USA, maximum 25 kOe). A B-H curve is illustrated in FIG. 3, and the values are shown in the following Table 1.

TABLE 1

| | Br | HCB | (BH)max |
|---|---|---|---|
| | (kG) | (kG) | (MGOe) |
| MnBi | 6.1 | 3.0 | 7.2 |
| MnBi/SmFeN (15 wt %) | 7.0 | 5.9 | 10.7 |
| MnBi/SmFeN (20 wt %) | 7.3 | 6.2 | 12.0 |
| MnBi/SmFeN (35 wt %) | 8.3 | 7.0 | 15.4 |

Referring to Table 1 and FIG. 3, it is confirmed that the MnBi/SmFeN (35 wt %) anisotropic complex sintered magnet of the present invention has a maximum energy product of 15.4 MGOe at a normal temperature (25° C.), and exhibits superior magnetic properties compared to a sintered magnet with a MnBi single phase as shown by the residual magnetic flux density (Br), the induced coercive force (H_{CB}), and the maximum magnetic energy product [(BH)max].

### Magnetic Properties of Anisotropic Complex Sintered Magnet at 150° C.

The residual magnetic flux density (Br), the induced coercive force (H_{CB}), and the maximum magnetic energy product [(BH)ₘₐₓ] of the MnBi and MnBi/SmFeN (15, 20, and 35 wt %) sintered magnets were measured at a high temperature (150° C.) by using a vibrating sample magnetometer (VSM, Lake Shore #7300 USA, maximum 25 kOe). A B-H curve is illustrated in FIG. 4, and the values are shown in the following Table 2.

TABLE 2

| | Br | HCB | (BH)max |
|---|---|---|---|
| | (kG) | (kG) | (MGOe) |
| MnBi | 5.3 | 5.0 | 6.7 |
| MnBi/SmFeN (15 wt %) | 6.1 | 4.4 | 8.0 |
| MnBi/SmFeN (20 wt %) | 6.5 | 4.3 | 8.5 |
| MnBi/SmFeN (35 wt %) | 7.6 | 4.3 | 11.4 |

Referring to Table 2 and FIG. 4, it is confirmed that the MnBi/SmFeN (35 wt %) anisotropic complex sintered magnet of the present invention has a maximum energy product of 11.4 MGOe at a high temperature (150° C.), and exhibits excellent magnetic properties as shown by the maximum magnetic energy product [(BH)max] because the induced coercive force (HCB) is decreased compared to a sintered magnet with an MnBi single phase. However, the residual magnetic flux density (Br) is increased due to the complexation of SmFeN. The MnBi/SmFeN (35 wt %) sintered magnet has an increased residual magnetic flux density (Br) at a high temperature (150° C.).

The foregoing embodiments and advantages are merely exemplary and are not to be considered as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A method of preparing an anisotropic complex sintered magnet comprising MnBi, the method comprising:
(a) preparing a non-magnetic phase MnBi-based ribbon by a rapidly solidification process (RSP);
(b) heat treating the non-magnetic phase MnBi-based ribbon to convert the non-magnetic phase MnBi-based ribbon into a magnetic phase MnBi-based ribbon;
(c) grinding the magnetic phase MnBi-based ribbon to form a MnBi hard magnetic phase powder;
(d) mixing the MnBi hard magnetic phase powder with a rare-earth hard magnetic phase powder;
(e) magnetic field molding the mixture obtained in step (d) by applying an external magnetic field to form a molded article; and
(f) sintering the molded article.

2. The method of claim 1, wherein the MnBi-based ribbon prepared in step (a) has a crystal grain size of 50 to 100 nm.

3. The method of claim 1, wherein the MnBi-based ribbon is further prepared using a cooling wheel during the rapidly solidification process, and wherein the cooling wheel has a circumference speed of 10 to 300 m/s.

4. The method of claim 1, wherein the MnBi-based ribbon in step (a) is represented by MnₓBi_{100 -x}, where X is 50 to 55.

5. The method of claim 1, wherein the heat treating of step (b) is performed at a temperature of 280 to 340° C.

6. The method of claim 1, wherein the MnBi hard magnetic phase powder has a diameter of 0.5 to 5 μm and the rare-earth hard magnetic phase powder has a diameter of 1 to 5 μm.

7. The method of claim 1, wherein the rare-earth hard magnetic phase is represented by R—Co or R—Fe—B, wherein R is a rare-earth element selected from the group consisting of Sc, Y, La, Ce, Pr, Nd, Pm, Sm, Eu, Gd, Tb, Dy, Ho, Er, Tm, Yb, and Lu.

8. The method of claim 1, wherein the rare-earth hard magnetic phase is SmFeN, NdFeB, or SmCo.

9. The method of claim 1, wherein a dispersing agent is added during the grinding the magnetic phase MnBi-based ribbon of step (c), wherein the dispersing agent is selected from the group consisting of oleic acid (C₁₈H₃₄O₂), oleylamine (C₁₈H₃₇N), polyvinylpyrrolidone, and polysorbate.

10. The method of claim 1, wherein a lubricant is added during the mixing of step (d), wherein the lubricant is selected from the group consisting of ethyl butyratebutyrate, methyl caprylatecaprylate, ethyl laurate, and stearate.

11. The method of claim 1, wherein the grinding the magnetic phase MnBi-based ribbon of step (c) is performed for 3 to 8 hours.

12. The method of claim 1, wherein the mixing of step (d) is rapidly performed within 1 minute to 1 hour for preventing the powders from being crushed.

13. The method of claim 1, wherein the sintering of step (f) is performed by a process selected from the group consisting of a hot press sintering, a hot isotactic press sintering, a spark plasma sintering, a furnace sintering, and a microwave sintering.

14. An anisotropic complex sintered magnet prepared by the method of claim 1, comprising:
MnBi; and
a rare-earth hard magnetic phase,
wherein the MnBi-based ribbon prepared in step (a) has a crystal grain size of 50 to 100 nm.

15. The anisotropic complex sintered magnet of claim 14, wherein the anisotropic complex sintered magnet comprises 55 to 99 wt % of the MnBi and 1 to 45 wt % of the rare-earth hard magnetic phase.

16. The anisotropic complex sintered magnet of claim 14, wherein the anisotropic complex sintered magnet has a maximum magnetic energy product (BHₘₐₓ) of 5 to 15 MGOe at a temperature from 25° C. to 150° C.

17. A product comprising the anisotropic complex sintered magnet of claim 14, wherein the product is selected from the group consisting of a compressor motor for refrigerator or air conditioner, a washing machine driving motor, a mobile handset vibration motor; a speaker, a voice coil motor, a linear motor, a zoom, an iris diaphragm, and a shutter of a camera, an actuator of a precision machine, a dual clutch transmission (DCT), an anti-lock brake system (ABS), an electric power steering (EPS) motor, and a fuel pump.

18. The method of claim 3, wherein the cooling wheel has a circumference speed of 30 to 100 m/s.

19. The method of claim 3, wherein the cooling wheel has a circumference speed of 60 to 70 m/s.

20. The method of claim 1, wherein the magnetic field molding is performed under a magnetic field of 0.1 to 5.0 T.
